(19) United States
(12) Patent Application Publication
(10) Pub. No.: US 2009/0241611 A1
(43) Pub. Date: Oct. 1, 2009

(54) Latch assembly

(75) Inventors: Donald Lee Brisco, Lake Elsinore, CA (US); Eryk Stacy, Silverado, CA (US)

Correspondence Address: WANG, HARTMANN & GIBBS, 1301 DOVE STREET, SUITE 1050, NEWPORT BEACH, CA, 92660, US

(73) Assignee: Fleetwood U.S.A., Corona, CA (US)

(21) Appl. No.: 12/079,874

(22) Filed: Mar. 27, 2008

(51) Int. Cl. E05B 65/08; E05C 19/12; E05B 15/00

(52) U.S. Cl. 70/95; 292/24; 70/447

(57) ABSTRACT

A door latch assembly having a latching mechanism and a substantially flush-mounted actuator. The actuator may raise and lower a latch within the latching mechanism to engage and disengage the strike plate of an adjacent door jam. Similar to the actuator, a key cylinder may be substantially flush-mounted on an opposite side of the door. The key cylinder may lock or unlock the latch assembly.

### FIELD OF THE INVENTION

This invention is generally related to latch assemblies, and more particularly to sliding door latch assemblies with actuators.

### BACKGROUND OF THE INVENTION

Sliding doors come in many varieties and have numerous applications. In homes, they can be made of wood, glass, metals, and combinations of other materials. Such doors may allow access to backyards, closets and other rooms. Often, interior doors, such as closet doors, are hung from the top, while heavier doors, such as exterior patio doors, glide along a lower rail. In some cases, the doors may be configured to slide out of the way and into pocket walls.

A key element of a sliding door is the latching assembly. This assembly generally includes a latching mechanism and an actuator. The latching mechanism includes a latch that physically secures the door to an adjacent object such as a door jam. The actuator acts on the latching assembly to lock and unlock the latch from a strike plate in the door jam. Existing actuators are typically unsightly as they protrude from the sliding door. These actuators may also catch clothing and other adjacent objects. Some latching assemblies also incorporate protruding hand pulls. The hand pulls may need more space to operate and may also catch on clothes or strike objects close to the door.

What is needed is a less-obtrusive latching assembly that retains the ability to secure and release the door in a user-friendly manner.

### SUMMARY OF THE INVENTION

A latching assembly for use in connection with a sliding door includes an actuator and a latching mechanism. The actuator is recessed within at least one side of the sliding door. The actuator is coupled to the latching mechanism. The latching mechanism is positioned within a frame of the door. The latching mechanism includes a latch to engage an adjacent object such as the strike plate in a door jam to secure the door closed.

To lock the door, a user may first slide the door into a closed position such that the door's leading edge abuts an adjacent door jam. The user may then rotate the actuator into a closed position. The actuator acts on the latching mechanism, which acts on the latch. The latch may include a hook to engage a strike plate on the adjacent door jam. By engaging the strike plate, the latch locks the door into the closed position. To open the door, the user rotates the actuator in the opposite direction. The actuator acts on the latching assembly to disengage the hook of the latch from the strike plate of the door jam. The user may then slide the door open. A key cylinder may be installed opposite of the actuator for locking and unlocking the sliding door from the opposite side.

These and other aspects of the invention will become apparent from a review of the accompanying drawings and the following detailed description of the invention.

### BRIEF DESCRIPTION OF THE DRAWINGS

The invention is generally shown by way of reference to the accompanying drawings in which:

FIG. 1 is a perspective view of a latch assembly;

FIG. 2 is a perspective view of a key cylinder and the latch assembly;

FIG. 3 is a perspective view of a latch assembly indicating the hook assembly;

FIG. 4 is a perspective view of handpulls; and

FIG. 5 is a perspective view of an embodiment having two latching assemblies.

FIG. 5A is another perspective view of the secondary latch mechanism;

### DETAILED DESCRIPTION OF THE INVENTION

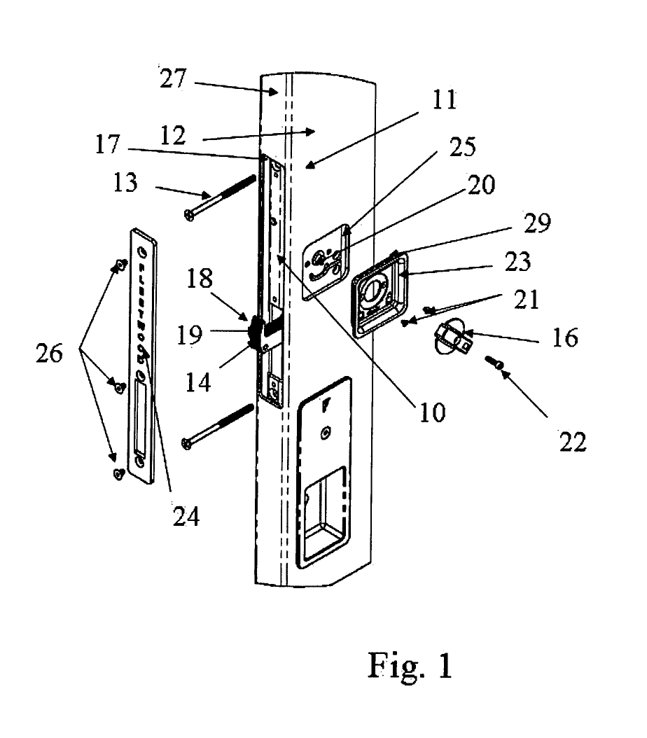

Some embodiments are described in detail with reference to the related drawings of FIGS. 1 through 5A. Additional embodiments, features and/or advantages will become apparent from the ensuing description or may be learned by practicing the invention. In the figures, which are not drawn to scale, like numerals refer to like features throughout the description. The following description is not to be taken in a limiting sense, but is made merely for the purpose of describing the general principles of the invention.

FIG. 1 illustrates one embodiment of a latching assembly 10 housed in the frame 11 of a sliding door 12. The latching assembly includes a latching mechanism 14 and an actuator 16 for operating the latching mechanism. The latching mechanism may be further up or down the frame from the actuator. In such cases, the latching mechanism is considered to be a distance from the actuator. A person of ordinary skill in the art would recognize that such a distance can be dictated by factors such as the location of the corresponding receiving area on a door jam. The latching assembly has essentially two positions—locked and unlocked. The latching mechanism has a latch 18 which may be raised and lowered by manipulation of the actuator to lock and unlock the door. The latch has a hook 19 thereon for engaging a strike plate of an adjacent object—such as a door jam—in a locking position. In this embodiment, the actuator has a rotational range of approximately 120 degrees between locked and unlocked positions.

Once closed, the user may lock the sliding door 12 by rotating the actuator 16 in a first direction to raise the latch 18 to engage a strike plate of an adjacent doorjam. The latch and the strike plate interlock to secure the door closed. To unlock the sliding door, the actuator may be rotated in an opposite direction to lower the latch and thereby release the strike plate. After release, the sliding door may be opened. In an alternative embodiment, a latch may be lowered to engage a strike plate and lock the door, rather than raised as shown here. Similarly, to unlock the door, a latch may be raised rather than lowered.

The actuator 16 is housed within a pocket 23. The pocket is fit within a first recess 25 in one side of the sliding door 12 and affixed to the sliding door with two screws 21. The pocket lies substantially flush with the side of the sliding door. In this embodiment, a pocket lip 29 protrudes approximately ⅛″ from the siding door. This near-flush fitment allows the sliding door to slide past adjacent panels or into a pocket wall. In other embodiments, this protrusion may be suitably altered including, but not limited to, a recessed fitting, flush mount or a larger protrusion. The pocket's recessed fitment here shields the actuator from inadvertent contact with clothing and other adjacent objects. In other embodiments, the pocket may be molded into the door frame.

The pocket and actuator are set back from the front edge 27 of the sliding door 12 to provide clearance between the doorjamb and the actuator 16 for easy manipulation. The actuator passes through the pocket 23 to affix to a square shaft flipper 20 through a screw 22. In another embodiment, the shaft flipper may be disposed a distance from the actuator. In such a case, the actuator could be, for example, higher or lower in the frame from the location of the shaft flipper. This would be understood to be a distance from the shaft flipper. A person of ordinary skill in the art would understand that the distance from the shaft flipper to the actuator could depend upon factors such as the ease of which a person of a particular height may access the shaft flipper. The square shaft flipper acts on internal components of the latching mechanism described below to raise and lower the latch 18 depending on the position of the actuator.

Still referring to FIG. 1, a front cover 24 is affixed into a second recess 17 in the front edge 27 of the sliding door 12. The front cover is recessed into the front edge such that when the door is closed, the entire front edge may uniformly abut the adjacent door jam. The latching mechanism 14 is secured to the sliding door 12 through the use of screws 13. The front cover is secured to the latching mechanism by screws 26. The latch 18 with the hook 19 thereon protrudes through the front cover for engaging the strike plate of the adjacent door jam.

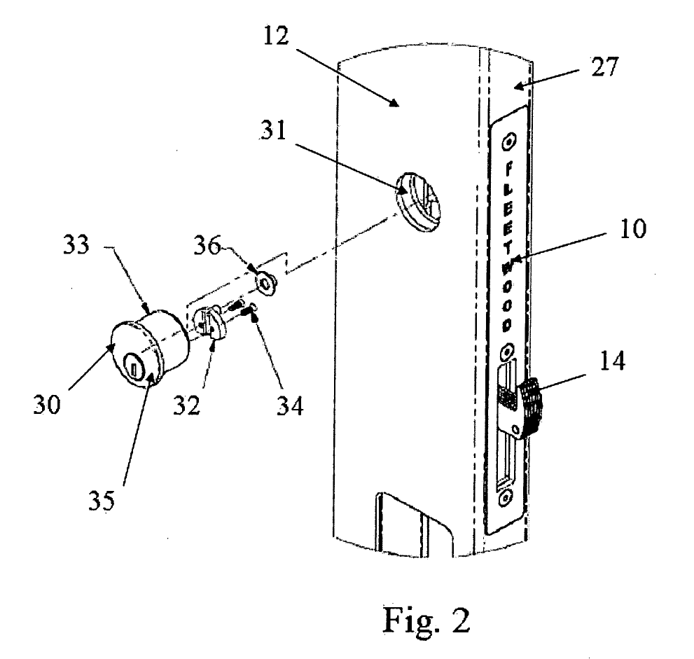

Referring now to FIG. 2, a key cylinder 30 is located on the opposite side of the sliding door 12 from the actuator and at a higher position. The key cylinder has a body 33 and a surface 35 and fits within a third recess 31 in the sliding door to lie substantially flush with the sliding door. In this embodiment, the surface of the key cylinder protrudes approximately ⅛″ from the siding door. This near-flush fitment allows the sliding door to slide past adjacent panels or into a pocket wall. In other embodiments, this protrusion may be suitably altered including, but not limited to, a recessed fitting, flush mount or a larger protrusion. Similar to the positioning of the actuator, the key cylinder is set back from the front edge 27 of the sliding door to provide clearance between the door jamb and the key cylinder for easy manipulation.

A cam 32 is fixed onto the end of the key cylinder through two screws 34. A first roller 36 is positioned on the end of the cam and configured to interact with the internal components of the latching mechanism 14. In operation, the key cylinder interacts with the cam and roller to lock and unlock the latching assembly 10—similar to the actuator locking and unlocking the latching assembly.

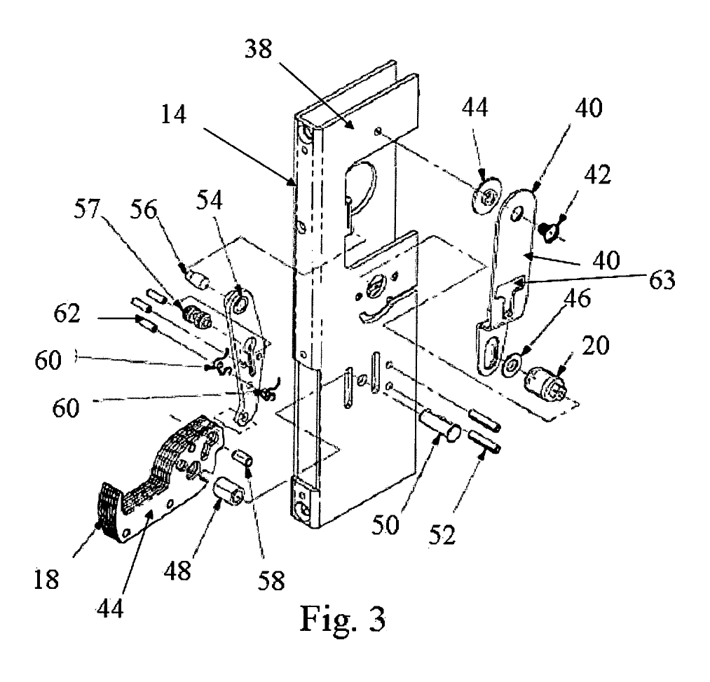

Referring now to FIG. 3, the latching mechanism 14 includes a housing 38, latch 18, and a number of additional components therein. In particular, a backing plate 40 for securing the square shaft flipper 20 is affixed to the interior of the housing. A screw 42 and washer 44 couple the upper portion of the backing plate to the housing while the square shaft flipper and a roller 46 extends into the lower portion of the backing plate. An activating plate 47 (not shown) is affixed to the backside of the square shaft flipper. The activating plate interfaces with the backing plate on one end and an actuating arm 54 on the other.

The latch 18 is located within the housing and a sleeve 48 is positioned within the latch. A pin 50 is inserted through the housing and through the sleeve to allow the latch to pivot up and down. Locating dowels 52 positioned through the housing limit the upward and downward movement of the latch.

The actuating arm 54 controls the movement of the latch 18. The actuating arm is coupled to the housing 38 through pin 56 and coupled to the latch through pin 58. Springs 60 are secured to the actuating arm through pin 62 to provide the arm with a detent position. A cam pin 57 cooperates with the actuating arm. The key cylinder 30 (not shown) is coupled to one side of the actuating arm to rotate the actuating arm through a T-slot 63, the manipulation of the key cylinder ultimately raising and lowering the latch. Through interaction with the T-slot, once the latch is completely raised, the cam 32 and first roller 36 fall with the lower portion of the “T.” Once positioned such that the latch is completely raised, the actuating arm, and therefore the latch, is fixed in a locked position. On the other side of the actuating arm, one end of the activating plate 47 (not shown) affixed to the square shaft flipper 20 interfaces with a second roller (not shown) coupled to the actuating arm to raise or lower the latch. At the same time, the other end of the activating plate rotates the backing plate 40 to rotate the key cylinder into corresponding locked or unlocked positions.

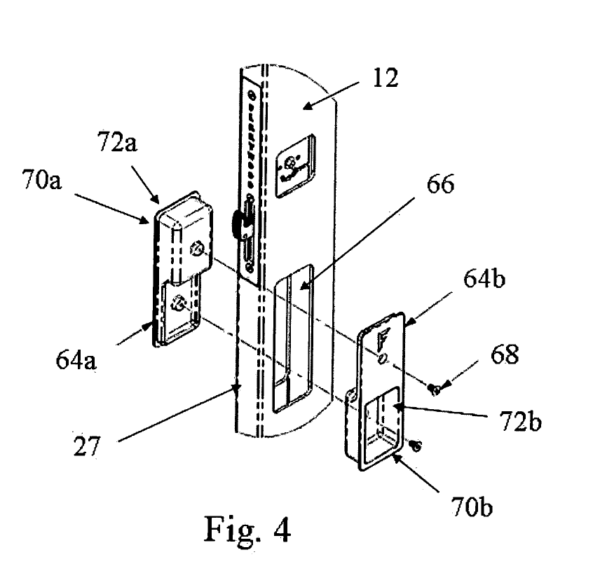

Referring now to FIG. 4, recessed hand pulls 64a and 64b are located within fourth recesses 66 in the sliding door 12 to lie substantially flush with the sliding door, similar to the near-flush placement of the actuator 16 and key cylinder 30. In this embodiment, hand pull lips 70a and 70b protrude approximately ⅛″ from the siding door. In this embodiment, the hand pulls are set back from the edge of the frame to provide additional clearance between the doorjamb and actuator. This near-flush fitment allows the sliding door to slide past adjacent panels or into a pocket wall. In other embodiments, this protrusion may be suitably altered including, but not limited to, a recessed fitting, flush mount or a larger protrusion. Similar to the positioning of the actuator and key cylinder, the hand pulls are set back from the front edge 27 of the sliding door to provide clearance between the doorjamb and the hand pulls for easy manipulation.

The hand pulls 64 are affixed to both sides of the sliding door 12 in an offset, interlocking relationship whereby screws 68 attach both hand pulls to each other. The offset arrangement, where one hand pull (64a) is oriented upwards and the other hand pull (64b) is oriented downwards, permits both hand pulls to have deep cavities for easy user manipulation. In this example, both hand pulls have cavities 72a, 72b approximately 1″ deep, although in alternative embodiments this depth may be altered as necessary.

In operation, once the sliding door 12 is in the closed position, the actuator 16 may be rotated to lock the sliding door 12 from one side, or a key may be inserted into the key cylinder 30 to lock the door from the other side. To unlock the sliding door, either the key may be inserted and rotated in the opposite direction or, from the other side of the door, the actuator may be rotated in the opposite direction.

In alternative embodiments, a second latch can be added to increase security. The door itself can be constructed from a variety of materials included by not limited to, wood, metal, fiberglass, and composite materials. The door can be solid or incorporate glass, i.e., a sliding glass door. The door can also be configured for a variety of applications including, but not limited to, residential, commercial, marine, and recreational vehicle applications. The actuator, key cylinder, latch assembly, and hand pulls can be made out of a number of materials including, but not limited to, brass, aluminum, steel, stainless steel, and composites and be configured with a number of finishes depending on application.

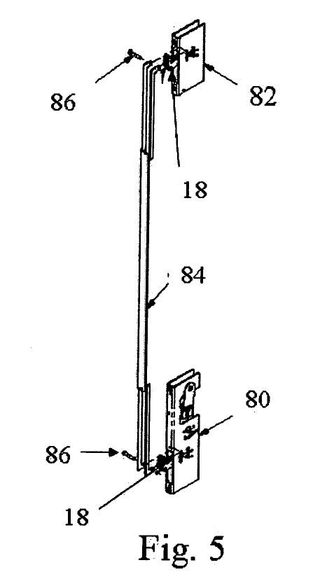

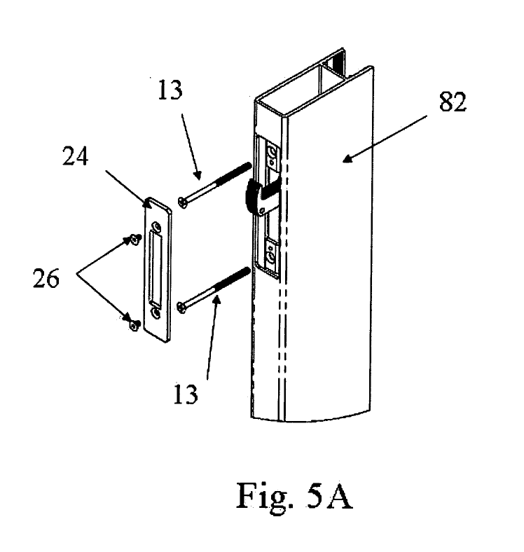

Now turning to FIG. 5, a primary latch assembly 80, is connected to a secondary latch assembly 82. The latch assemblies work together to secure the door in place. It will appreciated by one of skill in the art that two or more such assemblies can be combined and operate together or apart to secure the door in place. In this embodiment, the latch 18 of each assembly is operably connected by a linkage 84. Pins 86 connect the linkage 84 to the latches 18. It will also be appreciated by one of skill in the art that the linkage can take many forms and is not limited to the illustration of FIG. 5.

Referring to FIG. 5A, in an alternative embodiment the secondary latch mechanism 82 is secured to the sliding door by two screws 13 at the top and bottom. The front cover 24 attaches to the latching mechanism with two screws 26 and is primarily used to provide an esthetically pleasing cover. The recess in the sliding door is larger than the latch and the cover was designed to fill the recess.

While several embodiments have been described in detail, it should be appreciated that various modifications and/or variations may be made without departing from the scope or spirit of the invention. In this regard it is important to note that practicing the invention is not limited to the applications described herein above. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein above. Thus, it is intended that the invention cover all such embodiments and variations as long as such embodiments and variations come within the latch assembly of the appended claims and its equivalents.

What is claimed is:

1. A latching assembly for use with a door having a frame, a front edge, and two sides, the latching assembly comprising:
a pocket substantially flush-mounted in one side of the door;
an actuator substantially disposed within the pocket;
a latch mechanism disposed within the frame; and
a latch disposed within the latch mechanism;
wherein the latch assembly is responsive to the operation of the actuator such that the latch may extend from the front edge of the door and engage an adjacent object in a locking position.

2. The latching assembly of claim 1, wherein the latch assembly is responsive to the operation of the actuator such that the latch assembly is substantially enclosed within the front edge of the door in an unlocked position.

3. The latching assembly of claim 1, further comprising:
a key cylinder having a surface and a body;
the key cylinder body disposed within the frame substantially opposite of the knob and operable with the knob; and
the key cylinder surface being substantially flush with the frame;
wherein, the key cylinder is capable of transitioning the latch to a locking position.

4. The latching assembly of claim 1 further comprising a hand pull substantially flush with the side portion of the door.

5. A latching assembly for use with a sliding door, the sliding door having a frame, a front edge, and two sides, the latching assembly comprising:
a pocket having a body and a rim;
a knob;
a lever;
a latch mechanism having a hook;
the pocket being substantially recessed within the frame such that the rim of the pocket is substantially flush with one side of the door;
the actuator disposed within the pocket;
the lever disposed substantially within the frame and operable in response to the knob; and
a latching mechanism disposed substantially within the frame and operable in response to the lever;
wherein the knob is capable of actuating the lever which in turn actuates the latch mechanism such that the hook extrudes from the front edge of the door into a locking position.

6. The latching assembly of claim 5, wherein the knob is capable of actuating the lever which in turn actuates the latching mechanism such that the hook is substantially retracted into the body of the door in an unlocked position.

7. The latching assembly of claim 5, further comprising:
a key cylinder having a surface and a body;
the key cylinder body disposed within the frame on the opposite side of the door from the knob and operable with the knob; and
the key cylinder surface being substantially flush with the frame;
wherein, the key cylinder is capable of transitioning the hook to a locking position.

8. The latching assembly of claim 5 further including hand pulls that are substantially flush with the side portion of the frame.

9. A latching assembly for use with the frame of a sliding door, the latching assembly comprising:
a body having a front surface, a side surface, and an interior space;
a pocket disposed on the side surface and extending into the interior volume;
a knob dispose substantially within the pocket;
a hand pull disposed on the sliding door for moving the sliding door;
a hook assembly disposed within the interior surface and responsive to the operation of the knob such that the hook assembly is transitional between a locking position where the hook assembly is partially extruded from the front surface of the body and an unlocked position where the hook assembly is mostly enclosed within the body.

10. A latching assembly for use with the frame of a sliding door, the frame having a body, a front portion, and a side portion, the latching assembly comprising:
a recess within the side portion of the frame;
a knob substantially disposed within the recess; and
a hook assembly disposed within the body of the frame;
wherein the hook assembly is responsive to the operation of the knob such that the hook assembly is transitioned to a locking position.

11. The latching assembly of claim 10, further comprising:
a key cylinder having a surface and a body;
the key cylinder body disposed within the frame substantially opposite of the knob and operable with the knob; and
the key cylinder surface being substantially flush with the frame;
wherein, the key cylinder is capable of transitioning the hook to a locking position.

12. The latching assembly of claim 10 further including hand pulls that are substantially flush with the sides of the door.

13. A latching assembly for use with a sliding door having a body, a front portion, and sides, the latching assembly comprising:
a pocket having a body and a rim;
a knob;
a lever;
a hook assembly having a body and a hook;
the body of the pocket being substantially recessed within the frame such that the rim of the pocket is substantially flush with the side portion of the frame;
the knob disposed within the pocket;
the lever dispose substantially within the body of the frame and operable in response to the knob; and
the hook assembly disposed within the body of the frame and operable in response to the lever to the lever;
wherein the knob is capable of actuating the lever which in turn actuates the hook assembly such that the hook transitions to a locking position.

14. The latching assembly of claim 13 further including hand pulls that are substantially flush with the sides of the door.

15. A latching apparatus for use with a door having a frame, a front edge, and two sides, the latching assembly comprising:
a pocket substantially flush-mounted in one side of the door;
an actuator substantially disposed within the pocket;
a latch mechanism disposed within the frame;
a hand pull on each side of the frame and each handpull being offset from the other; and
a latch disposed within the latch mechanism;
wherein the latch assembly is responsive to the operation of the actuator such that the latch may extend from the front edge of the door and engage an adjacent object in a locking position.

16. A latching apparatus for use with a door having a frame, a front edge, and two sides, the latching assembly comprising:
a pocket substantially flush-mounted in one side of the door;
an actuator substantially disposed within the pocket;
a latch mechanism disposed within the frame and the latch mechanism disposed a distance from the actuator; and
a latch disposed within the latch mechanism;
wherein the latch assembly is responsive to the operation of the actuator such that the latch may extend from the front edge of the door and engage an adjacent object in a locking position.

17. A latching apparatus for use with a door having a frame, a front edge, and two sides, the latching assembly comprising:
a pocket substantially flush-mounted in one side of the door;
an actuator substantially disposed within the pocket;
a shaft flipper, where the actuator is disposed a distance from the shaft flipper;
a latch mechanism disposed within the frame; and
a latch disposed within the latch mechanism;
wherein the latch assembly is responsive to the operation of the actuator, which is responsive to operation of the shaft flipper, such that the latch may extend from the front edge of the door and engage an adjacent object in a locking position.

18. A latching structure for use with a door having a frame, the latching structure comprising;
a primary latch assembly integrated with the frame;
a secondary latch assembly integrated with the frame; and
a linkage;
wherein the linkage operably connects the primary and secondary latch assemblies such that the latch assemblies operate substantially in unison.
